(19) United States
(12) Patent Application Publication
(10) Pub. No.: US 2006/0216448 A1
(43) Pub. Date: Sep. 28, 2006

(54) Methods for processing poly(cyclohexylenedimethyleneterephthalate) and products produced therefrom

(76) Inventor: Gerald Timothy Keep, Kingsport, TN (US)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/089,115

(22) Filed: Mar. 24, 2005

(51) Int. Cl. D01F 1/02; B32B 27/08

(52) U.S. Cl. 428/35.7; 264/211

(57) ABSTRACT

The present invention is a method for making an article, such as a fiber, filament, monofilament, film, sheet, nonwoven, or parison, etc., including a poly(cyclohexylenedimethylene terephthalate) (PCT) polymer. A polymeric PCT crystallization modifying additive is added to a PCT polymer in an amount sufficient to suppress crystallization of an article formed of a melt of the PCT polymer as the article cools, yet without preventing crystallization of the PCT polymer when the article is subsequently oriented.

### FIELD OF THE INVENTION

The present invention relates to a method for processing polymers including terephthalic acid and cyclohexanedimethanol components using a polymeric additive, as well as products produced therefrom.

### BACKGROUND OF THE INVENTION

Polyesters have long been recognized as desirable materials for the production of numerous consumer and industrial products worldwide because of their strength, heat resistance, and chemical resistance, among other properties. For example, polyethylene terephthalate (PET) is widely used in the production of molded articles, bottles, containers, food trays, fibers, films, and nonwovens.

Many automotive, electronic, and industrial uses can require polyester articles with high resistance to aqueous or caustic media. In addition, many such uses can require that the polyester products have a higher temperature capability than PET provides. Polyester polymers derived from the reaction of terephthalic acid and cyclohexanedimethanol, e.g., poly(1,4-cyclohexylenedimethylene terephthalate) or PCT, can be useful in these and others applications requiring improved hydrolytic stability and higher temperature capability.

Despite its advantageous properties, PCT is not widely used in the commercial production of polymeric articles due in part to difficulties associated with processing the same. In this regard, cyclohexanedimethanol exists as a cis- and a trans-isomer. Use of the trans-isomer results in a polymer that is highly crystalline. The highly crystalline PCT polymer, however, can be intractable and thus difficult to process.

Addition of the cis-isomer of cyclohexanedimethanol (typically about 30%) can reduce the melting point of the PCT polymer so that it is more readily melt processable. Substitutions present in either the dicarboxylic acid component, or the glycol component, or both, of the PCT polymer can further reduce its melting point to provide additional processing benefits. As an example, the dicarboxylic acid component can include 5% to 12%, and in some cases as much as 18%, isophthalic acid to provide a crystalline resin suitable for the production of extruded or thermoformed products, such as fibers and monofilaments, including spiral-crimped filaments used in paper machine clothing.

As the PCT polymer is increasingly modified, for example via adipic acid and other aliphatic, cycloaliphatic and aromatic acids, the resultant resin becomes more amorphous in nature. As an example, increasing the percentage of isophthalic acid can result in a material with significantly reduced crystallinity. Similarly, replacing some percentage of the cyclohexanedimethanol glycol component with ethylene glycol (EG) can result in a more amorphous copolymer (referred to as PCTG), which is used as a binder fiber and in polymer blends. These materials are typically only molded in amorphous, unoriented states that do not take advantage of the properties that derive from the high melting point of the PCT polymer.

Modified PCT copolymers have found use as additives blended with other polymers such as polycarbonates to render the blend fully amorphous and ductile. As an example, U.S. Pat. No. 4,188,314 to Fox et al. is directed to a polycarbonate composition stated to be useful for forming shaped articles. The composition includes an aromatic carbonate polymer as the majority component and a polyester polymer as a minority component. The polyester is derived from the reaction of cyclohexanedimethanol with a mixture of terephthalic acid and isophthalic acid. The '314 patent states that articles produced from the polycarbonate composition are transparent, which is an indicator of their amorphous nature. The '314 patent further contrasts the transparent products with articles shaped from a polyester composition, which are stated to have a pronounced tendency to crystallize and change from transparent to opaque-translucent.

Plasticizers have also been proposed as additives for improving the processing of various polymers, including PCT, particularly for injection molding applications. For example, U.S. Pat. Nos. 5,965,648 and 5,624,987, each to Brink et al., are directed to the use of polyalkylene ethers as plasticizers in poly (1,4-cyclohexanedimethylene terephthalate) resins. The patent states that the polyalkylene ether plasticizers decrease the melt viscosity and depress the glass transition temperature of the PCT composition, which in turn can increase crystallization rate at a lower temperature. Thus, the plasticizer actually enhances the amount of crystallinity present in some cases. While a plasticized material will yield more readily, it can also exhibit an increased propensity to craze (e.g., form crystalline hard points or “crazes”) and not strain harden. Stated differently, plasticizers promote crystal formation on first cooling in molding but then locks the product in that state, resulting in a brittle product having lower toughness and decreased durability. This is undesirable for post-processing techniques, such as orientation, and for layered films or unicomponent and multicomponent fibers.

### BRIEF SUMMARY OF THE INVENTION

The present invention includes a method for making a PCT article having crystalline properties. In contrast to conventional products made of PCT polymers and conventional processing techniques used to make the same, the present invention improves the processability of the PCT polymer without sacrificing desirable properties thereof. As discussed in more detail below, as used herein, the term “PCT polymer” refers to polymers including terephthalic acid units and cyclohexanedimethanol (“CHDM”) units, as well as derivatives and/or modifications of such polymers. As a non-limiting example, the term PCT polymer as used herein includes PCT polymers having isophthalic acid and/or other acid units as well as terephthalic acid units (e.g. PCTA polymers), as well as EG and CHDM and/or other glycol units (e.g., PCTG polymers).

This aspect of the invention includes adding a polymeric PCT crystallization modifying additive to a PCT polymer in an amount sufficient to modify the crystalline behavior of the PCT polymer and forming an intermediate article of a melt of the PCT polymer and the additive. Other additives, such as but not limited to antioxidants and a carbodiimide stabilizer such as Staboxy®, may also be included, without adversely impacting the working of the invention. The polymeric PCT crystallization modifying additive is present in an amount sufficient to retard crystallization of the PCT polymer as the article cools from the melt to a glassy state. The amount of polymeric PCT crystallization modifying additive present, however, does not prevent crystallization of the PCT polymer when the formed intermediate article is oriented after the cooling step, such as by drawing, stretching, or blow molding. This is particularly helpful in high speed spinning of fibers, for example at speeds above 4500 meters/minute, which can result in better filament uniformity and the like.

The PCT polymer of the invention includes a dicarboxylic acid component including terephthalic acid units and optionally including a modifying dicarboxylic acid unit having about 4 to about 40 carbon atoms. The PCT polymers also include a glycol component including cyclohexanedimethanol units and optionally including a modifying glycol unit having about 2 to about 20 carbon atoms. PCT polymers consisting essentially of 1,4-cyclohexanedimethanol and terephthalic acid units and PCT polymers consisting essentially of 1,4-cyclohexanedimethanol, terephthalic acid, and isophthalic units can be particularly useful in the present invention.

The PCT crystallization modifying additive can be a polymer substantially miscible and/or compatible with the PCT polymer, including polycarbonates, polyarylates, polyether imides, polyether sulfones, polyesteramides, and mixtures thereof. One currently advantageous embodiment of the invention uses a polycarbonate additive, and in particular an aromatic polycarbonate derived from the reaction of a dihydric phenol such as bisphenol A with a suitable carbonate precursor. The additive is provided as a minority component of a blend or mixture of the additive with the PCT polymer. The additive can be present, for example, in an amount ranging from about 0.3 to about 5 weight percent, based on the total weight of the composition.

Another aspect of the present invention includes PCT articles having crystalline properties. The present invention also includes PCT articles that are not yet crystalline but which are capable of crystallizing upon orientation, including articles whose function requires them to crystallize on orientation during use, e.g., to absorb strain. The present invention further includes compositions including a PCT polymer and a polymeric PCT crystallization modifying additive and methods for making the same.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

As used in the specification, and in the appended claims, the singular forms “a”, “an”, and “the” include plural referents unless the context clearly dictates otherwise.

The polymer compositions of the present invention include a polycondensation polymer derived from the reaction of cyclohexanedimethanol with terephthalic acid. The resultant polyester polymer has repeat units of at least terephthalic acid and cyclohexanedimethanol and is generally referred to herein as a poly(cyclohexylenedimethylene terephthalate) (or PCT) polymer. Accordingly, as used herein, the term “PCT polymer” refers to polymers including terephthalic acid units and cyclohexanedimethanol units. The term “PCT polymer” as used herein also refers to derivatives and/or modifications of poly(cyclohexylenedimethylene terephthalate), for example, PCT polymers including derivatives of terephthalic acid and/or cyclohexanedimethanol, as well as PCT polymers including other dicarboxylic acid units and/or other glycol units that are different from terephthalic acid and cyclohexanedimethanol, as described in more detail below. Accordingly, as used herein, the term “PCT polymer” includes crystalline copolyesters. PCT polymers in accordance with the present invention also include derivatives thereof that include modifiers such as polyesteramides, dual functional additives like para-hydroxy benzoic acid, and the like.

The PCT polymer of the invention includes a dicarboxylic acid component comprising terephthalic acid units. As used herein, the term “dicarboxylic acids” includes the corresponding acid anhydrides, esters, and acid chlorides of these acids. The mole percentage of the dicarboxylic acid component(s) of the PCT polymers referred to herein equals a total of 100 mole percent.

The dicarboxylic acid component of the PCT polymer can include from about 80 to about 100 mole percent, and up to about 90 to about 100 mole percent, of terephthalic acid, based on the mole percentages of the dicarboxylic acid component of the polyester equaling a total of 100 mole percent. Advantageously, the PCT polymer includes 100 mole percent terephthalic acid, although other dicarboxylic acid(s) can be present in alternative embodiments of the invention, as discussed in more detail below. As used herein, the term “terephthalic acid” includes suitable synthetic equivalents, such as dimethyl terephthalate.

The dicarboxylic acid component can optionally include at least one modifying dicarboxylic acid unit that is different from the terephthalic acid unit. For example, PCT polymers useful in this invention can include 0 to about 20 mole percent of at least one, or more, dicarboxylic acids other than terephthalic acid, based on the mole percentage of the dicarboxylic acid component of the PCT polymer equaling a total of 100 mole percent.

Exemplary optional modifying dicarboxylic acids include, but are not limited to, aromatic dicarboxylic acids having about 4 to about 40 carbon atoms, for example, aromatic dicarboxylic acids having about 8 to about 14 carbon atoms; aliphatic dicarboxylic acids having about 4 to about 40 carbon atoms, for example, aliphatic dicarboxylic acids having about 4 to about 12 carbon atoms; cycloaliphatic dicarboxylic acids having about 6 to about 40 carbon atoms, for example cycloaliphatic dicarboxylic acids having about 8 to about 12 carbon atoms, and mixtures thereof.

Exemplary optional modifying dicarboxylic acids useful in the PCT polymer of the invention include, but are not limited to, isophthalic acid, naphthalenedicarboxylic acid, cyclohexanedicarboxylic acid, 1,4-cyclohexanediacetic acid, diphenyl-4,4′-dicarboxylic acid, succinic acid, glutaric acid, adipic acid, azelaic acid, sebacic acid, 1,12-dodecanoic acid, and the like, as well as derivatives thereof (such as but not limited to naphthalenedicarboxylate), and mixtures thereof. Of these, isophthalic acid can be particularly useful in amounts ranging from about 0 to about 18 mole percent, based on the mole percentage of the dicarboxylic acid component of the PCT polymer. When cyclohexanedicarboxylic acid is used as a comonomer in the context of the invention, trans-, cis-, or cis/trans mixtures may be used. In addition, any of the naphthalenedicarboxylic acid isomers or mixtures of isomers may be used, such as, for example, the 2,6-, 2,7- 1,4- and 1,5-isomers.

The PCT polymers of the invention further include a glycol component including 1,4-cyclohexanedimethanol (“CHDM”) units. The mole percentage of the glycol component(s) of the PCT polymers referred to herein equals a total of 100 mole percent.

The glycol component of the PCT polymer can include from about 70 to about 100 mole percent, and up to about 90 to about 100 mole percent, of one or more isomers of 1,4-cyclohexanedimethanol. Advantageously, the PCT polymer includes 100 mole percent of one or more isomers of 1,4-cyclohexanedimethanol, although other glycol(s) can be present in alternative embodiments of the invention, as discussed in more detail below. The PCT polymers of the invention can be based the cis- or the trans-isomer, or mixtures of both cis- and trans-isomers, of 1,4-cyclohexanedimethanol. As a non-limiting example, a 30/70 cis/trans mixture of the isomers can be used.

The glycol component of the PCT polymer can optionally include at least one modifying glycol unit that is different from the 1,4-cyclohexanedimethanol unit. For example, PCT polymers useful in this invention can include up to about 30 mole percent, and up to about 10 mole percent, of one or more other aliphatic or alicyclic glycols.

Exemplary optional glycols include cycloaliphatic diols having about 6 to about 20 carbon atoms; aliphatic diols having about 2 to about 20 carbon atoms; and mixtures thereof. Examples of such diols include, but are not limited to, ethylene glycol, diethylene glycol, triethylene glycol, propane-1,3-diol, butane-1,4-diol, pentane-1,5-diol, hexane-1,6-diol, 3-methylpentanediol-(2,4), 2-methylpentanediol-(1,4), 2,2,4-trimethylpentane-diol-(1,3), 2-ethylhexanediol-( 1,3), 2,2-diethylpropane-diol-(1,3), hexanediol-(1,3), 1,2-propane diol, 1,8-octanediol, neopentyl glycol, 1,4-di-(hydroxyethoxy)-benzene, 2,2-bis-(4-hydroxycyclohexyl)-propane, 2,4-dihydroxy-1,1,3,3-tetramethyl-cyclobutane, 2,2-bis-(3-hydroxyethoxyphenyl)-propane, decalin diol, 2,2-bis-(4-hydroxypropoxyphenyl)-propane, and the like, and derivatives and mixtures thereof.

The total mole percent of optional modifying dicarboxylic acid units and/or optional modifying glycol units and/or cis-CHDM is selected to provide the PCT polymer with a crystallinity suitable for a particular end use, for example, a crystallinity comparable to that exhibited by nylon 66 at 265° C. Generally, the total mole percent of optional modifying dicarboxylic acid units and/or optional modifying glycol units and/or cis-CHDM will not exceed about 40 mole percent. As a non-limiting example, a PCT polymer that includes about 30 mole percent cis-CHDM will generally include no more than about 10 mole percent of optional modifying dicarboxylic acid units and/or optional modifying glycol units. In addition, the PCT polymer will generally include less than 20 mole percent ethylene glycol to provide the desired crystallization.

PCT polymers including substantially only 1,4-cyclohexanedimethanol and terephthalic acid or substantially only 1,4-cyclohexanedimethanol, terephthalic acid and isophthalic acid (generally in an amount up to about 5 mole percent of the dicarboxylic acid component) can be particularly useful in the present invention.

PCT polymers useful in the invention are well known and are commercially available. Methods for their preparation are described, for example, in U.S. Pat. Nos. 2,465,319 and 3,047,539. For example, the polyesters can be prepared by direct condensation of terephthalic acid or ester interchange using dimethyl terephthalate with the selected glycol. Typical catalysts which may be used to make the PCT polymers include titanium alkoxides, dibutyl tin dilaurate, combinations of zinc, manganese, or magnesium acetates, benzoates, or other catalyst salts with antimony oxide or antimony triacetate.

The PCT polymers of the invention can have an inherent viscosity (I.V.) of about 0.1 to about 2.0 deciliter/gram (dL/g), such as an inherent viscosity of about 0.6 to about 1.2 dL/g, as measured at a temperature of 25° C. for a 0.5 gram sample in 100 ml of a solvent consisting of 60% by weight phenol and 40% by weight tetrachloroethane. The basic method of determining the I.V. of a polyester is set forth in ASTM D-2857-95. The PCT polymers can have a melting point of greater than 260° C., such as a melting temperature greater than 270° C. Typically, the crystalline PCT polymer has a melting point ranging from about 250° C. to about 31° C. Melting points for PCT polymers and their oriented, drawn forms useful in the invention can be measured by DSC (differential scanning calorimetry) analysis, as is known in the art.

Polymeric PCT crystallization modifying additives useful in the present invention include any polymeric additive that is capable of slowing, suppressing or retarding crystallization of a melt of a PCT polymer as it cools or is systematically quenched to form an intermediate article. The polymeric PCT crystallization modifying additive, however, should not prevent crystallization of the PCT polymer when the intermediate article is subsequently processed, for example, by orienting the PCT polymeric intermediate article by drawing, blow molding, and the like. Accordingly, as used here, the term “intermediate article” refers to the initial product formed as the PCT polymer melt cools and prior to subsequent downstream processing of the article to orient, or fully orient, the PCT polymer. The intermediate article can be described as generally amorphous, with a glassy initial appearance. The intermediate article can also be described as having a latent crystallinity that develops when subjected to a subsequent orientation step after the melt cools. Alternatively, the operation can be combined in some cases with orientation occurring in the latter stages of the initial cooling, as for instance the material first approaches its glass transition temperature (Tg).

The compositions and products produced therefrom in accordance with the present invention have crystalline properties and can be described as semi-crystalline in nature. In contrast, many prior polycarbonate compositions with PCT as a component are amorphous, and crystallization is prevented to maintain the desired ductile behavior and to impart transparency, among other properties. The terms “amorphous,” “crystalline” and “semi-crystalline” are understood in the polymer art and as used herein refer to a material's inherent ability to crystallize when referring to material type, or alternatively its current state of crystallinity when referring to a particular product or object. The compositions and products produced therefrom in accordance with the invention are capable of exhibiting some degree, and in some applications a substantial degree, of crystallinity, typically from about 20 to about 70% final crystallinity after drawing, stretching, etc., as measured using conventional techniques known in the art. Often, the drawn, stretched forms are post-stabilized by thermal or other methods, to reduce internal stresses.

As used herein, the terms “slowing” or “suppressing” or “retarding” crystallization of the PCT polymer refers to minimizing the rate of crystallization of the composition as it cools from a melt into a glassy state to form an intermediate article. The crystallization properties of the PCT polymer are merely suppressed or retarded until the intermediate article is subjected to some additional processing step to initiate or recover the polymer's inherent crystalline nature. Accordingly, an intermediate article formed by cooling a melt of the polymer composition can exhibit minimal or substantially no crystallization, e.g., less than 10 percent crystallization. In the present invention, however, because crystallization is allowed to resume when the intermediate article is subsequently processed, the polymer composition and articles made therefrom can be described as semi-crystalline as defined above. This is in contrast to prior polycarbonate/polyester blends, which remain substantially amorphous.

Advantageously, the polymeric PCT crystallization modifying additive is substantially miscible and/or compatible with the PCT polymer in the melt. As used herein, the term “miscible” refers to blends of polymers that are a mixture on a molecular level wherein intimate polymer-polymer interaction is achieved. Differential scanning calorimetry (DSC) testing can sometimes detect a single glass transition temperature (T_{g}) for miscible blends of two or more polymers. For some blends, DSC can sometimes show miscibility by finding a single Tg that is intermediate between those of the blended components.

Exemplary polymeric additives capable of slowing or suppressing, but not preventing, crystallization of the PCT polymer in accordance with the present invention include, for example, polycarbonates, polyarylates, polyether imides, polyether sulfones, polyesteramides, and the like, and mixtures thereof. Polycarbonates are particularly useful as the PCT crystallization modifying additive.

Any polycarbonate can be used in accordance with the invention. Polycarbonates suitable for use in the present invention are well known and are generally commercially available. The polycarbonates may be prepared by a variety of conventional and well known processes which include transesterification, melt polymerization, interfacial polymerization, and the like.

Advantageously, the additive is an aromatic polycarbonate additive. Aromatic polycarbonates are generally prepared by reacting a dihydric phenol with a carbonate precursor, such as phosgene. Particularly useful polycarbonates include aromatic polycarbonates based on bisphenol A (4,4′-isopropylidenediphenol), such as are obtained by reacting bisphenol A with at least one carbonate ester, such as but not limited to, phosgene, dibutyl carbonate, diphenyl carbonate, and the like, as well as mixtures thereof.

Exemplary aromatic carbonate polymers useful in the present invention include polymers with the recurring units of formula I: 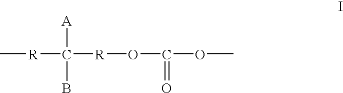
wherein:

each R is selected from the group consisting of phenylene and substituted phenylene, including, for example, halo-substituted phenylene and alkyl-substituted phenylene; and

A and B are each selected from the group consisting of hydrogen, hydrocarbon radicals free from aliphatic unsaturation and radicals which together with the adjoining 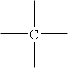
atom form a cycloalkane radical, the total number of carbon atoms in A and B being up to 12. Such aromatic polycarbonate polymers are known in the art and are described, for example, in U.S. Pat. No. 3,989,672, the entire disclosure of which is hereby incorporated by reference. See also Encyclopedia of Polymer Science and Technology, Vol. 10, pages 710-727, 1969, Interscience of New York, and Baron et al., U.S. Pat. No. 4,034,016, both of which are incorporated herein by reference.

The polycarbonate can be, for example, a high molecular weight polymer having the formula II: 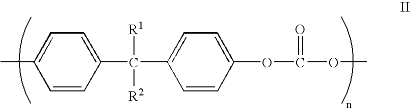
wherein:

R¹ and R² are hydrogen, lower alkyl or phenyl; and

n is at least 30, and preferably 40 to 400. The term “lower alkyl as used herein includes hydrocarbon groups of from 1 to 6 carbon atoms.

Particularly advantageous polycarbonates can be derived from the reaction of bisphenol A and phosgene. Exemplary polycarbonates of this types useful in the present invention can have from 10 to 400 recurring units of the formula

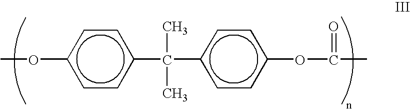

The polycarbonate can have an intrinsic viscosity between 0.3 and 1.1 dl/g, as measured at 25° C. in methylene chloride or a similar solvent.

The polymeric PCT crystallization modifying additive is a minority component of a blend or mixture of the additive with a PCT polymer, and accordingly is used in low concentrations. As an example, the additive can be present in a composition of the PCT polymer and the additive in an amount ranging from about 0.3 to about 5 weight percent, based on the total weight of the composition. As another example, the additive can be present in an amount ranging from about 0.5 to about 3 weight percent, based on the total weight of the composition. In yet another example, the additive can be present in an amount ranging from about 1 to about 2 weight percent, based on the total weight of the composition. The upper limit of additive used in accordance with the present invention can be readily determined based upon the inability of the glassy material of the intermediate article to recover crystallinity on orientation.

The composition can contain other conventional additives as known in the art, such as, but not limited to, stabilizers, flame retardants, flame retardant synergists, tougheners, epoxy compounds, branching agents, mold release agents, nucleating agents, antioxidants, delustrants, reinforcing agents such as reinforcing fibers and fillers (such as carbon or glass fibers), fillers, antioxidants, colorants including carbon black, impact modifiers, UV absorbers, pigments, carbodiimides such as Staboxyl® and the like, and mixtures thereof. Additives such as plasticizers and nucleators which themselves change crystallization rate will of course shift the range of polymeric PCT crystallization modifying additive that is effective, accordingly. Such additives can be present in the composition in conventional amounts. When present, the additives can be added during or after polymerization of the PCT polymer, depending on the nature of the additive.

The melt stability and color of the composition of the invention can be further improved by addition of a phosphorous-based compound as is also known in the art. Exemplary phosphorous-based compounds include, but are not limited to, one or more phosphites, phosphonites and phosphates, wherein at least one of the P—O bonds is attached to an aryl radical, such as those disclosed in U.S. Pat. No. 6,277,905, which is hereby incorporated by reference. The phosphorous-based compounds can also be used in conventional amounts.

To improve polymer toughness, modulus can be reduced to initiate shear yielding before crazing begins (e.g., before crystalline hard points, or crazes, begin to form). If crazing occurs first, the product will be brittle and may lose uniformity. If crazing does not happen at all, however, the result is a soft material that fails to neck. Thus, to provide a tough material, crazing and shear yielding properties should balance.

Although not bound by any explanation or theory of the invention, it is currently believed that the following mechanisms may be at work in the invention. First, in the present invention, the intimate molecular scale presence of the additive is believed to hinder the initial crystallization of the PCT polymer. The less crystalline form of the PCT polymer accordingly yields more easily (i.e., at a lower stress) in advance of craze formation.

Second, the additive is believed to increase the free volume content in the intermediate article, again allowing more ready shear yielding. Upon orienting the material to form the final article, however, the PCT chains are believed to slide past the additive chains until they come to other PCT chains and are able to resume their normal crystalline structure. This can lead to strength increases in the oriented material to a higher point than the yield point, thereby allowing necking behavior that can be critical in processing thermoplastic polymers. When a thin piece of a plastic material necks down and gets stronger, the stress is transferred to other parts of the article and the likelihood of catastrophic failure of the article can be diminished. In processing, this draw point must be controlled and not allowed to move erratically or linearly forward and backwards.

Accordingly, because the present invention hinders initial crystallization of the PCT polymer, thereby lowering modulus, in contrast to prior techniques (such as the addition of plasticizers discussed above), the polymer can begin to shear yield. Yet, the polymer also crystallizes as the shear action orients the materials.

The PCT polymer and the polymeric PCT crystallization modifying additive can be blended and/or mixed in any of various forms, for example, as powders, pellets, granules, or in any other extrudable form, or as melt forms, using any suitable technology known in the art, including melt blending, dry blending and/or extrusion compounding, and combinations thereof. For example, the PCT polymer and the additive can be mixed dry in any suitable blender or tumbler and the dry mixture thereafter melt processed, for example, melt extruded, blow molded, and the like. Melt forms of the PCT polymer and additive can also be blended and/or mixed together. The melt mixed blend can be directly melt processed. Alternatively, the melt mixed blend can be pelletized, granulated or otherwise comminuted into a desired particulate size or size distribution and fed to an extruder that melt processes the blended mixture. As yet another example, a dry form of the additive can be added to a melt form of the PCT polymer, for example, by adding the dry additive to the PCT polymer in a melt extruder.

Advantageously the thermal history of the blend is minimized to avoid excess reaction between the two polymers, which might result in an irreversible fusion of the two that would prevent the crystallization of the PCT. A stabilizer to prevent such a reaction can also be used, such as the above-mentioned phosphorous containing compounds, or other catalyst deactivating agents as known in the art.

The PCT polymer and additive as described herein can be melt processed in a variety of shapes or forms, including fibers, woven and nonwoven fabrics, spunbond and meltblown fabrics, molded parts, bottles, extruded profiles, extrusion coatings, containers, sheeting, film, laminates, and the like. The invention is meant to incorporate all melt processing methods known in the art. As used herein, the term “melt processing“refers to any processing step commonly used in the art for PCT polymers which occurs after the PCT polymers are heated above their melting temperature or melting point. This includes, but is not limited to, fiber extrusion, film extrusion, and blow molding.

Melt-processing typically is performed at a temperature from about 270 to about 350° C., although optimum operating temperatures are selected depending upon the melting point, melt viscosity, and thermal stability of the blend. Different types of extruders, blenders, molding machines, and the like that may be used to extrude the compositions of this invention are well known in the art and can include any of the types of extruders, blenders, molding machines, and other apparatus as known for melt extruding fibers, films and other shaped articles.

Exemplary articles in accordance with the present invention include, but are not limited to, fibrous materials, such as monofilament fibers having a denier of at least about 20 to over 1000, staple fibers having a denier of less than about 100, continuous multifilament yams having a denier per filament of less than 100, and microdenier fibers and filaments resulting from or derived from bicomponent and/or multicomponent fiber techniques such as splittable fibers or islands-in-the-sea cross-sections. Bicomponent and multicomponent fiber constructions are well known in the art, and, as used herein, the term “multicomponent” includes bicomponent fibers, including sheath/core, pie-wedge, islands-in-the-sea, and side-by-side fiber configurations. The bicomponent and multicomponent fibers of the invention include at least one or more components formed of the PCT polymer and polymeric PCT crystallization modifying additive as discussed herein. Other exemplary articles of the invention include films having a thickness of less than about 0.5 mm. Other non-limiting exemplary articles in accordance with the present invention include sheet materials having a thickness of greater than about 0.5 mm, parisons, and blow molded articles.

Products produced in accordance with the present invention can exhibit better hydrolytic stability during use, non-matting in washing, and higher temperature capability (including higher melt points and Tg) as compared to PET products. Fibers formed of the PCT polymers of the invention exhibit additional desirable properties such as resiliency, low shrinkage, and durable soft hand; higher tenacity; lower draw tensions in drafting; lower density/specific gravity than PET and more bulk than PET; and easier dyeability. Round and shaped fibers prepared in accordance with the present invention are suitable for carpets and scatter rugs, apparel fleece and sliver knits, electrical applications, paper machine clothing and other cost-effective belting for high temperature, high moisture applications, filtration, insulation, and the like. Consumer product examples include but are not limited to apparel, bed pads, paint rollers, and saddle blankets.

A number of physical properties can be improved as a direct consequence of the increased orientation of PCT polymers, including PCTA polymers, provided by this invention. Increased orientation enables higher degrees of crystallinity, via stress-induced crystallization, which in turn causes higher modulus and strength or tenacity. Materials should heatset more readily and provide lower shrinkage upon later exposure to heat. These and other improvements in properties come from increased orientation of a finished article. As such, these improvements are implied by the general reference to improved orientation. This invention also increases the possibility for use of PCT in POY (partially oriented yarn) and mechanical texturing.

In addition, the changes in orientability provided by this invention directly change the ultimate draw and shrinkage of PCT and/or PCTA, which can be a powerful tool in designing and manufacturing bicomponent (or multicomponent) fibers. In some fibers, it is desirable to more fully draw and orient all materials to a high degree. This invention can increases the ultimate draw of PCT and PCTA and therefore can allow it to function in a bicomponent configuration with other materials that also have high ultimate draw ratios, such as PET, without a mismatch developing. Conversely, a variety of effects can be achieved by deliberately mismatching the drawability and/or shrink recovery of two materials in a bicomponent fiber. Examples include generation of spiral crimped fiber, self-texturing fibers, and elastic yarns, as well as yarns to add a unique fashion appearance to fabrics. Thus, the ability to design improved bicomponent fiber architectures is implied by the general reference to changed or improved orientability.

Matched shrinkage can result in more uniform filaments and is much more suitable for 2- and 3-stage drawing. Mis-match can lead to separations at the layer interface, peel backs, lower durability and resilience, surface cracks, less stiff fiber, and the like.

The present invention will be further illustrated by the following non-limiting example.

98% of a poly(cyclohexylenedimethylene terephthalate) with about 30% cis-CHDM isomer content, such as is available from Eastman Chemical Company as PCT 13787, with 0.77 dL/g pellet IV is melt blended with 2% of a polycarbonate available from Bayer as Makrolon OR 2608 and the blend is formed into an intermediate article. The PCT article exhibits a yield point at about 40 MPa stress, elongates 400%, and then breaks at a final stress of about 60 MPa. This article can be formed into a final article by elongation with strong, oriented regions, for example as a drawn fiber, stretched film, or blow molded bottle. Fiber tenacities of about 5 grams/denier can be achieved for typical nonwoven and textile deniers and greater than or equal to about 4 grams/denier for larger monofilaments. The highly oriented end product can also be heatset to a higher degree, and/or at lower temperatures, than is normally possible with PCT polymers, which are sometimes heatset at 200-205° C. More permanent spiral crimp and stuffer box crimp can also be obtained. Similar results are obtained with PCTA 13319 from Eastman Chemical Company having a 0.96 dL/g pellet IV. Fibers and filaments (including bulked continuous filament and monofilament) of this invention have much higher twisting and braiding efficiencies (much fewer twisting breaks) and higher weaving efficiencies than their unmodified controls.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A method for making an article including a (cyclohexylenedimethylene terephthalate) (PCT) polymer, the method comprising:
adding a polymeric PCT crystallization modifying additive to a PCT polymer in an amount ranging from about 0.3 to about 5 weight percent, based on the total weight of the additive and PCT polymer;
forming an intermediate article from a melt of said additive and PCT polymer; and
cooling or quenching said intermediate article, wherein said additive retards crystallization of the PCT polymer as the article cools without preventing crystallization of the PCT polymer when said intermediate article is oriented after said cooling step.

2. The method of claim 1, further comprising orienting said intermediate article to initiate crystallization of said PCT polymer after said cooling or quenching step.

3. The method of claim 1, wherein said PCT polymer has an inherent viscosity ranging from about 0.1 to about 2.0 deciliter/gram (dL/g).

4. The method of claim 3, wherein said PCT polymer has an inherent viscosity ranging from about 0.6 to about 1.2 dL/g.

5. The method of claim 1, wherein said adding step comprises adding an additive that is substantially miscible or compatible with said PCT polymer.

6. The method of claim 1, wherein said adding step comprises adding an additive in an amount ranging from about 0.5 to about 3 weight percent, based on the total weight of the additive and PCT polymer.

7. The method of claim 6, wherein said adding step comprises adding an additive in an amount ranging from about 1 to about 2 weight percent, based on the total weight of the additive and PCT polymer.

8. The method of claim 5, wherein said adding step comprises adding an additive selected from the group consisting of polycarbonates, polyarylates, polyether imides, polyether sulfones, polyesteramides, and mixtures thereof.

9. The method of claim 8, wherein said adding step comprises adding a polycarbonate.

10. The method of claim 9, wherein said adding step comprises adding an aromatic polycarbonate.

11. The method of claim 10, wherein said adding step comprises adding an aromatic polycarbonate comprising repeating units of formula I: 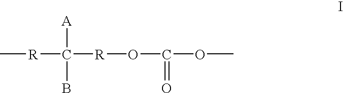
wherein:
each R is selected from the group consisting of phenylene and substituted phenylene; and
A and B are each selected from the group consisting of hydrogen, hydrocarbon radicals free from aliphatic unsaturation and radicals which together with the adjoining 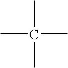
form a cycloalkane radical, the total number of carbon atoms in A and B being up to 12.

12. The method of claim 11, wherein each R is phenylene and each of A and B is methyl.

13. The method of claim 1, wherein said PCT polymer comprises:
a dicarboxylic acid component comprising terephthalic acid units and optionally a modifying dicarboxylic acid unit having about 4 to about 40 carbon atoms; and
a glycol component comprising cyclohexanedimethanol units and optionally a modifying glycol unit having about 2 to about 20 carbon atoms.

14. The method of claim 13, wherein said PCT polymer comprises:
a dicarboxylic acid component comprising terephthalic acid units and about 0 to about 18 mole percent isophthalic acid units; and
a glycol component comprising cyclohexanedimethanol units.

15. The method of claim 13, wherein said PCT polymer comprises:
a dicarboxylic acid component comprising terephthalic acid units; and
a glycol component comprising cyclohexanedimethanol units and about 0 to about 20 mole percent ethylene glycol units.

16. The method of claim 12, wherein said PCT polymer comprises:
a dicarboxylic acid component consisting essentially of terephthalic acid units and about 0 to about 18 mole percent isophthalic acid units; and
a glycol component consisting essentially of cyclohexanedimethanol units.

17. The method of claim 16, wherein said cyclohexanedimethanol units are derived from a mixture of cis- and trans-isomers of cyclohexanedimethanol.

18. The method of claim 1, wherein the step of adding a polymeric PCT crystallization modifying additive to a PCT polymer comprises dry blending said additive and said PCT polymer.

19. The method of claim 1, wherein the step of adding a polymeric PCT crystallization modifying additive to a PCT polymer comprises adding said additive to a melt of said PCT polymer.

20. An article produced according to the method of claim 1.

21. The article of claim 20, selected from the group consisting of fibrous materials, nonwoven fabrics, films, sheet materials, and molded products.

22. An article produced according to the method of claim 2.

23. The article of claim 22, selected from the group consisting of fibrous materials, nonwoven fabrics, films, sheet materials, and molded products.

24. An oriented article having crystalline properties, comprising a poly(cyclohexylenedimethylene terephthalate) (PCT) polymer and a polymeric PCT crystallization modifying additive in an amount ranging from about 0.3 to about 5 weight percent, based on the total weight of the PCT polymer and the additive.

25. The article of claim 24, wherein said article comprises drawn fibrous material.

26. The article of claim 25, wherein said drawn fibrous material comprises a monofilament having a denier greater than about 20.

27. The article of claim 25, wherein said drawn fibrous material comprises a staple fiber having a denier less than about 100.

28. The article of claim 25, wherein said drawn fibrous material comprises a multifilament fiber having a denier per filament less than about 100.

29. The article of claim 25, wherein said drawn fibrous material is a multicomponent fiber, wherein at least one component therein comprises said PCT polymer and said polymeric PCT crystallization modifying additive.

30. The article of claim 24, comprising a film having a thickness of less than about 0.5 mm.

31. The article of claim 24, comprising a sheet material having a thickness of greater than about 0.5 mm.

32. The article of claim 20, comprising a parison.

33. The article of claim 24, comprising a blow molded article.

34. An undrawn article, comprising a substantially non-crystalline poly(cyclohexylenedimethylene terephthalate) (PCT) polymer and a polymeric PCT crystallization modifying additive in an amount ranging from about 0.3 to about 5 weight percent, based on the total weight of the PCT polymer and the additive, wherein said PCT polymer comprises latent crystallization properties so that the PCT polymer crystallizes when the intermediate article is drawn.

35. A method for making a polymer composition useful for the production of crystalline articles formed of poly(cyclohexylenedimethylene terephthalate) (PCT) polymer, comprising adding a polymeric PCT crystallization modifying additive to a PCT polymer in an amount ranging from about 0.3 to about 5 weight percent, based on the total weight of the additive and PCT polymer, wherein said additive retards crystallization of the PCT polymer as an intermediate article made of a melt thereof cools without preventing crystallization of the PCT polymer when said intermediate article is oriented after cooling or quenching.

36. A polymer composition useful for the production of crystalline articles formed of poly(cyclohexylenedimethylene terephthalate) (PCT) polymer, comprising:
a poly(cyclohexylenedimethylene terephthalate ) (PCT) polymer; and
a polymeric PCT crystallization modifying additive in an amount ranging from about 0.3 to about 5 weight percent, based on the total weight of the additive and PCT polymer, wherein said additive retards crystallization of the PCT polymer as an intermediate article made of a melt thereof cools without preventing crystallization of the PCT polymer when said intermediate article is oriented after cooling or quenching.

37. The article of claim 34, comprising a film having a thickness of less than about 0.5 mm.

38. The article of claim 34, comprising a sheet material having a thickness of greater than about 0.5 mm.

39. The article of claim 34, comprising a parison.
